(19) United States
(12) Patent Application Publication
(10) Pub. No.: US 2026/0084120 A1
(43) Pub. Date: Mar. 26, 2026

(54) BUBBLE GENERATION DEVICE, BUBBLE GENERATION METHOD, AND METHOD OF PRODUCING BUBBLE GENERATING MEMBER

(71) Applicant: Kagoshima University, Kagoshima (JP)

(72) Inventor: Takashi GOSHIMA, Kagoshima (JP)

(21) Appl. No.: 19/111,733

(22) PCT Filed: Sep. 7, 2023
(86) PCT No.: PCT/JP2023/032622

§ 371 Date: Mar. 13, 2025

(30) Foreign Application Priority Data
Sep. 14, 2022 (JP) 2022-146253

(51) Int. Cl. B01F 23/231; B01F 23/232

(52) U.S. Cl. CPC B01F 23/23121; B01F 23/2323; B01F 2215/0431

(57) ABSTRACT

A bubble generating nozzle (100) defines a gas flow path (110). The gas flow path (110) discharges bubbles (FB) formed of a gas introduced thereto via one end (110a) into a static liquid (LQ) from the other end (110b). The bubble generating nozzle (100) satisfies a relationship of L>24.0×(D²/4ν), where a length of the gas flow path (110) from the one end (110a) to the other end (110b), an equivalent diameter of the gas flow path (110), and a kinematic viscosity of the gas are L [m], D [m], and ν [m²/s], respectively.

### TECHNICAL FIELD

The present disclosure relates to a bubble generating nozzle, a bubble generation device, a bubble generation method, and a method of producing a bubble generating nozzle.

### BACKGROUND ART

As tubular nozzles for discharging bubbles into a liquid, nozzles used in the mode of increasing the fineness of bubbles (hereinafter, referred to as “bubble refining nozzles”) and nozzles used in the mode of generating bubbles (hereinafter, referred to as “bubble generating nozzles”) are known.

A bubble refining nozzle is used in a so-called dynamic bubble generation device in which bubbles are refined by a process such as dissolution or shearing. A gas-liquid mixed fluid in which bubbles are mixed into a liquid in advance is introduced to the bubble refining nozzle. In the dynamic bubble generation device, the gas-liquid mixed fluid is locally pressurized or depressurized using the bubble refining nozzle and pressurizing means such as a liquid pump that forces a liquid to flow. As a result, the bubbles contained in the gas-liquid mixed fluid are dissolved or sheared, and thereby refined.

On the other hand, a gas, instead of a gas-liquid mixed fluid, is introduced to a bubble generating nozzle. The gas introduced to the bubble generating nozzle is discharged as bubbles from the tip of the bubble generating nozzle into a liquid. As disclosed in Patent Literature 1, a bubble generation device that includes such a bubble generating nozzle can be realized by a simple configuration in which the bubble generating nozzle is connected to a gas supply source.

### CITATION LIST

### Patent Literature

Patent Literature 1: Unexamined Japanese Patent Application Publication No. 2019-136638

### SUMMARY OF INVENTION

### Technical Problem

In the above-described dynamic bubble generation device, since the resulting bubbles tend to vary in size and operation of the pressurizing means is necessary, not only contamination is likely to occur but also the temperature of the liquid is likely to be increased. Therefore, there are cases where it is desirable to generate bubbles using a bubble generating nozzle in a so-called static bubble generation device without the use of the pressurizing means.

However, even in such cases, it is not easy to generate bubbles having a uniform size. It is also not easy to constantly and stably generate bubbles using a bubble generating nozzle, that is, to generate bubbles under a condition where pulsation is inhibited. Therefore, it is an important problem to establish a method of designing a bubble generating nozzle that can discharge bubbles having a uniform size and hardly causes pulsation during the discharge of bubbles.

An objective of the present disclosure is to provide: a bubble generating nozzle that can discharge bubbles having a uniform size and hardly causes pulsation during the discharge of bubbles; a bubble generation device and a bubble generation method, in which the bubble generating nozzle is used; and a method of producing a bubble generating nozzle, the method being suitable for the production of the bubble generating nozzle.

### Solution to Problem

A bubble generating nozzle according to the present disclosure is a bubble generating nozzle, defining a gas flow path into which a gas is introduced from one end, and that discharges bubbles formed of the gas into a static liquid from an other end,
wherein the bubble generating nozzle satisfies a relationship of L>24.0×(D²/4ν), where a length of the gas flow path from the one end to the other end, an equivalent diameter of the gas flow path, and a kinematic viscosity of the gas are L [m], D [m], and ν [m²/s], respectively.

The length L of the gas flow path may be 0.3×10⁻³ [m] or more.

The length L of the gas flow path may be 1×10⁻³ [m] or more.

The length L of the gas flow path may be 100×10⁻³ [m] or less.

The equivalent diameter D of the gas flow path may be 1×10⁻⁶ [m] to 100×10⁻⁶ [m].

A bubble generation device according to the present disclosure includes:
the bubble generating nozzle according to the present disclosure;
a gas storage chamber that defines a cavity communicating with the gas flow path of the bubble generating nozzle, the cavity having a volume larger than a volume of the gas flow path; and
a gas supply source that supplies the gas to the cavity of the gas storage chamber.

A bubble generation method according to the present disclosure includes:
preparing a bubble generating nozzle defining a gas flow path; and
introducing a gas into the gas flow path from one end of the gas flow path, and repeatedly discharging bubbles formed of the introduced gas into a static liquid from an other end of the gas flow path,
wherein the bubble generating nozzle satisfies a relationship of L>24.0×(D²/4ν), where a length of the gas flow path from the one end to the other end, an equivalent diameter of the gas flow path, and a kinematic viscosity of the gas are L [m], D [m], and ν [m²/s], respectively.

In the introducing of the gas, the gas may be introduced into the gas flow path via a gas storage chamber that is connected to an end of the bubble generating nozzle on a side in which the one end of the gas flow path is open.

A method of producing a bubble generating nozzle according to the present disclosure is a method of producing a bubble generating nozzle defining a gas flow path into which a gas is introduced from one end, and that discharges bubbles formed of the gas into a static liquid from an other end, wherein
the method includes:
preparing a workpiece from which the bubble generating nozzle is derived; and
subjecting the workpiece to a removal process of removing a portion of the workpiece, and thereby forming the gas flow path in the workpiece, and in the subjecting, the gas flow path that satisfies a relationship of L>24.0×(D²/4ν), where a length of the gas flow path from the one end to the other end, an equivalent diameter of the gas flow path, and a kinematic viscosity of the gas are L [m], D [m], and ν [m²/s], respectively, is formed by the removal process.

In the subjecting, the gas flow path may be formed by performing wire electric discharge machining as the removal process.

### Advantageous Effects of Invention

According to the bubble generating nozzle of the present disclosure, bubbles having a uniform size can be discharged, and pulsation is unlikely to occur during the discharge of the bubbles.

### BRIEF DESCRIPTION OF DRAWINGS

FIG. 1 is a cross-sectional view of the bubble generating nozzle according to Embodiment 1;

FIG. 2 is a conceptual diagram illustrating a configuration of the bubble generation device according to Embodiment 1;

FIG. 3 is a scatter diagram showing the relationships between the length L of the gas flow path and the physical quantity R²/ν in the bubble generating nozzles according to Experimental Examples 1 to 15;

FIG. 4 is a flow chart of the method of producing a bubble generating nozzle according to Embodiment 1; and

FIG. 5 is a cross-sectional view of the bubble generating nozzle and the gas storage chamber according to Embodiment 2.

### DESCRIPTION OF EMBODIMENTS

The bubble generating nozzle and the bubble generation device according to the embodiments are hereinafter described with reference to the drawings. In the drawings, same reference signs denote the same or corresponding components.

### Embodiment 1

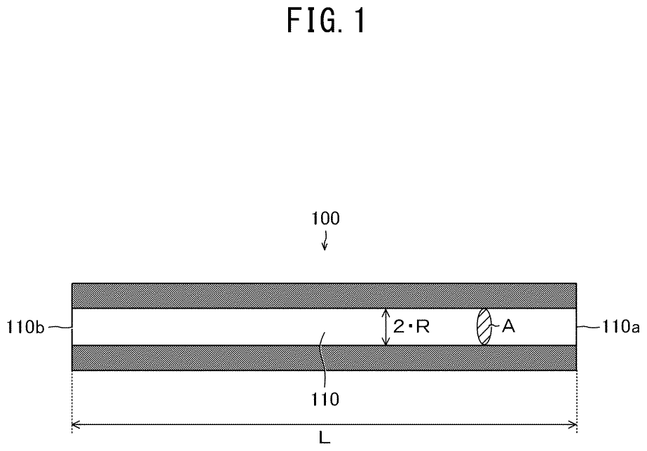

FIG. 1 illustrates a cross-sectional view of a bubble generating nozzle 100 according to the present embodiment. The bubble generating nozzle 100 defines a gas flow path 110 through which a gas passes.

The gas is introduced from one end (hereinafter, referred to as “gas introduction end”) 110a of the gas flow path 110. The other end (hereinafter, referred to as “bubble discharge end”) 110b of the gas flow path 110 is arranged in a liquid. The gas introduced from the gas introduction end 110a passes through the gas flow path 110, and bubbles formed of the gas are discharged from the bubble discharge end 110b.

In the present embodiment, the gas flow path 110 is defined in the shape of a straight column, specifically a right circular cylinder. The bubble generating nozzle 100 defining the right circular cylindrical gas flow path 110 is constituted by a straight tubular body having an opening on both ends. That is, one opening of the tubular body is the gas introduction end 110a, and the other opening is the bubble discharge end 110b.

A mode of use of the bubble generating nozzle 100 is concretely described below.

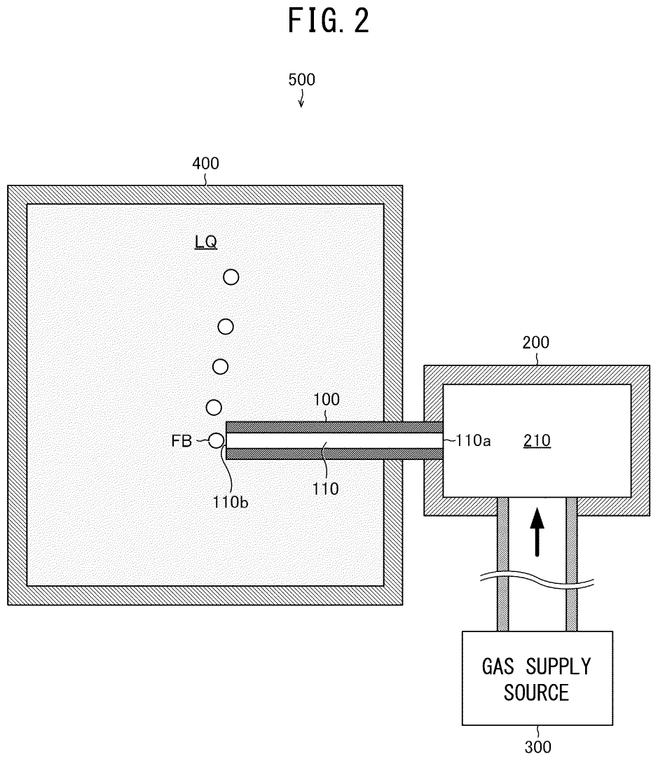

FIG. 2 illustrates a configuration of a bubble generation device 500 that includes the above-described bubble generating nozzle 100. The bubble generation device 500 includes: a liquid tank 400 that can store a liquid LQ; the bubble generating nozzle 100 that has a straight tubular shape and discharges bubbles FB into the liquid LQ stored in the liquid tank 400; a gas storage chamber 200 that is connected to the bubble generating nozzle 100; and a gas supply source 300 that supplies a gas to the gas storage chamber 200.

The gas storage chamber 200 defines a cavity 210. The cavity 210 is in communication with the gas flow path 110 of the bubble generating nozzle 100. The volume of the cavity 210 is larger than the volume of the gas flow path 110. It is noted here that, in the present specification, the concept of “gas storage chamber” excludes gas pipes used for gas transportation. A member that defines a gas-accumulating space at an end or in a middle part of a gas pipe is the gas storage chamber.

In the present embodiment, the gas storage chamber 200 is connected to an end of the bubble generating nozzle 100 on a side in which the gas introduction end 110a is open. However, a gas pipe that connects the cavity 210 and the gas flow path 110 may exist between the gas storage chamber 200 and the bubble generating nozzle 100.

The gas supply source 300 is constituted by a gas pump, a gas cylinder, or the like. The gas supply source 300 supplies a gas to the cavity 210 of the gas storage chamber 200. The gas supplied to the cavity 210 flows into the gas flow path 110 of the bubble generating nozzle 100 from the gas introduction end 110a.

The gas flowing into the gas flow path 110 passes through the gas flow path 110 and is continuously discharged as bubbles FB into the liquid LQ from the bubble discharge end 110b. According to the bubble generation device 500, bubbles FB having a diameter of, for example, less than 300 μm, more specifically 100 μm or less, that are so-called fine bubbles, can be generated.

As described above, in a so-called dynamic bubble generation device (not illustrated), a locally increased or reduced pressure field is formed in a liquid by a pressurizing means such as a liquid pump, and bubbles are forcibly dissolved or sheared in the pressure field and thereby refined. In contrast, what is illustrated in FIG. 2 is the bubble generation device 500 that is static. That is, in the bubble generation device 500 according to the present embodiment, a pressurizing means for forming the local pressure field is not used.

The bubble generation device 500 according to the present embodiment can be used in a mode of continuously and repeatedly discharging bubbles FB one after another into a macroscopically static liquid (hereinafter, referred to as “static liquid”) LQ without substantially disturbing the liquid LQ in the liquid tank 400. The term “macroscopically static” used herein means that the liquid LQ can be deemed to have a uniform pressure and a flow rate of zero when macroscopically observed in terms of space and time, specifically that the above-described pressure field for actively refining the bubbles FB is not formed.

Particularly in such a mode of static use, it may be desirable to reduce a variation in the size of the bubbles FB and to constantly and stably discharge the bubbles FB.

However, conventionally, there are problems that it is difficult to make the size of the bubbles FB uniform, and that pulsation may occur during the discharge of the bubbles FB. Particularly, a configuration that includes the gas storage chamber 200 has a problem that a variation in the size of the bubbles FB and pulsation are likely to occur due to changes in the gas pressure in the cavity 210, local pressure non-uniformity, and the like.

In view of the above, the present inventor attempted to solve the above-described problems by optimizing the shape of the bubble generating nozzle 100 for the gas used. Experimental Examples in which an optimal shape of the bubble generating nozzle 100 was explored for solving the above-described problems are described below.

### EXPERIMENTAL EXAMPLES

First, main factors that determine the length of the gas flow path 110 required for solving the above-described problems were examined. As illustrated in FIG. 1, the “length of the gas flow path 110” refers to a length L from the gas introduction end 110a to the bubble discharge end 110b.

The cross-sectional area of the gas flow path 110 is considered as a first factor that determines the required length of the gas flow path 110. As illustrated in FIG. 1, the “cross-sectional area of the gas flow path 110” refers to a cross-sectional area A of the gas flow path 110 that is perpendicular to the direction of gas flow (hereinafter referred to as “lengthwise direction”). The cross-sectional area A of the gas flow path 110 can be expressed as A∝R², wherein R is the radius of the gas flow path 110 that is perpendicular to the lengthwise direction.

It is believed that the larger the cross-sectional area A∝R² of the gas flow path 110, the more likely the density and the pressure of the gas in the gas flow path 110 to be locally non-uniform. Accordingly, in order to realize a uniform size of the bubbles FB and inhibition of pulsation, a greater length L of the gas flow path 110 is believed to be necessary for a larger cross-sectional area A∝R² of the gas flow path 110.

Further, the kinematic viscosity ν of the gas used is considered as a second factor that determines the required length of the gas flow path 110. It is believed that the higher the kinematic viscosity ν of the gas, the less likely the density and the pressure of the gas in the gas flow path 110 to be locally non-uniform. Accordingly, the higher the kinematic viscosity ν of the gas, the shorter the length L of the gas flow path 110 believed enough to realize a uniform size of the bubbles FB and inhibition of pulsation.

As described above, the first factor A∝R² has an effect toward an increase in the required length L of the gas flow path 110, while the second factor ν has an effect toward a decrease in the required length L of the gas flow path 110. Therefore, R²/ν was assumed as a physical quantity f (A∝R², ν) that encompasses the first factor A∝R² and the second factor ν and determines the required length L of the gas flow path 110.

Various combinations of the length L of the gas flow path 110 and the physical quantity R²/ν were actually configured and, in each configuration, the uniformity of the size of generated bubbles FB and the discharge stability of the bubbles FB (hereinafter, collectively referred to as “bubble generation characteristics”) were examined. This is concretely described below.

Straight tubular bubble generating nozzles 100 according to Experimental Examples 1 to 15 that had different combinations of the length L of the gas flow path 110 and the radius R of the gas flow path 110, were produced. Bubbles FB were actually generated using each of the bubble generating nozzles 100 according to Experimental Examples 1 to 15, and the bubble generation characteristics were verified. As a gas constituting the bubbles FB, air was used in all of Experimental Examples 1 to 15. Further, the static liquid LQ was water.

Table 1 shows the length L and the radius R of the gas flow path 110 in the respective bubble generating nozzles 100 according to Experimental Examples 1 to 15, as well as the results of verifying the bubble generation characteristics.

TABLE 1

| | Gas flow path | | Bubble generation |
|---|---|---|---|
| | Length L [m] | Radius R [m] | characteristics |
| Experimental | 5 × 10⁻⁴ | 1 × 10⁻⁶ | ∘ |
| Example 1 | | | |
| Experimental | 3.5 × 10⁻⁴ | 1 × 10⁻⁶ | ∘ |
| Example 2 | | | |
| Experimental | 3 × 10⁻⁶ | 1 × 10⁻⁶ | ∘ |
| Example 3 | | | |
| Experimental | 5 × 10⁻² | 3.5 × 10⁻⁶ | ∘ |
| Example 4 | | | |
| Experimental | 3 × 10⁻² | 3.5 × 10⁻⁶ | ∘ |
| Example 5 | | | |
| Experimental | 1 × 10⁻² | 3.5 × 10⁻⁶ | ∘ |
| Example 6 | | | |
| Experimental | 5 × 10⁻³ | 3.5 × 10⁻⁶ | ∘ |
| Example 7 | | | |
| Experimental | 3.5 × 10⁻⁴ | 5 × 10⁻⁶ | ∘ |
| Example 8 | | | |
| Experimental | 5 × 10⁻² | 1 × 10⁻⁵ | ∘ |
| Example 9 | | | |
| Experimental | 3 × 10⁻² | 1 × 10⁻⁵ | ∘ |
| Example 10 | | | |
| Experimental | 1 × 10⁻² | 1 × 10⁻⁵ | ∘ |
| Example 11 | | | |
| Experimental | 3.5 × 10⁻⁴ | 1 × 10⁻⁵ | ∘ |
| Example 12 | | | |
| Experimental | 1 × 10⁻¹ | 6.5 × 10⁻⁵ | ∘ |
| Example 13 | | | |
| Experimental | 5 × 10⁻⁵ | 7.5 × 10⁻⁶ | x |
| Example 14 | | | |
| Experimental | 1 × 10⁻⁴ | 1.5 × 10⁻⁵ | x |
| Example 15 | | | |

In Table 1, “◯” means that the bubble generation characteristics were excellent, that is, the bubbles FB were sufficiently uniform in size and discharged stably and constantly without pulsation. On the other hand, “X” means that there was a problem in the bubble generation characteristics, specifically that the bubbles FB were not uniform in size, or pulsation occurred during the discharge of the bubbles FB.

Experimental Examples 1 to 13 exhibited excellent bubble generation characteristics, corresponding to Examples. On the other hand, Experimental Examples 14 and 15 had a problem in the bubble generation characteristics, corresponding to Comparative Examples.

The kinematic viscosity ν of the air used as a gas in Experimental Examples 1 to 15 is 15.12×10⁻⁶ [m²/S]. Using this value and each value of the radius R shown in Table 1, the above-described physical quantity R²/ν was calculated.

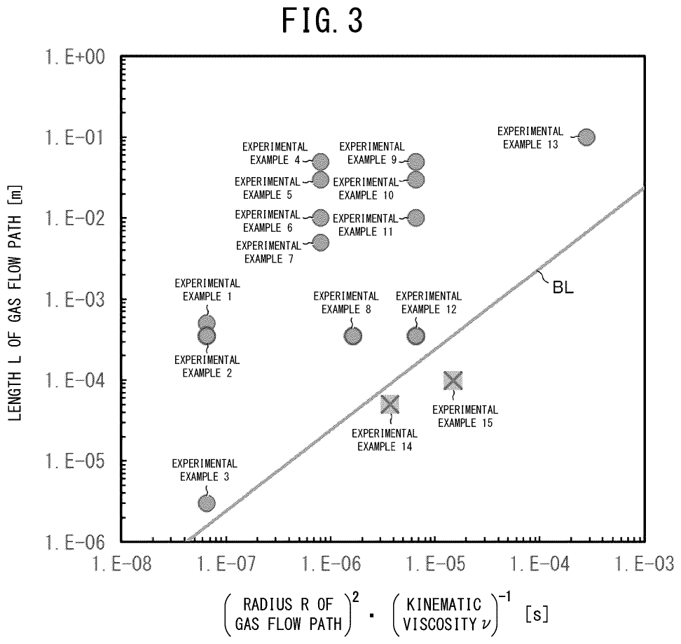

FIG. 3 is a scatter diagram obtained by plotting the data points determined by combinations of the calculated physical quantity R²/ν and the length L of the gas flow path 110 shown in Table 1. The ordinate represents the length L of the gas flow path 110 in [m]. The abscissa represents the physical quantity R²/ν in [s]. In other words, when the radius R of the gas flow path 110 is expressed in [m] and the kinematic viscosity is expressed in [m²/S], the dimension of the physical quantity R²/ν is [s]. The ordinate and the abscissa are both on a logarithmic scale.

As shown in FIG. 3, as a result of presenting the combinations of the length L of the gas flow path 110 and the physical quantity R²/ν in a scatter diagram, there was found a borderline BL that distinguishes Experimental Examples 1 to 13 as Examples from Experimental Examples 14 and 15 as Comparative Examples. In other words, in FIG. 3, preferred bubble generation characteristics are obtained above the borderline BL, that is, in a region where the length L is larger than the value on the borderline BL.

The borderline BL is indicated as a straight line on the double logarithmic scatter diagram shown in FIG. 3. When the slope of the straight line and the intercept with the ordinate were read from FIG. 3, the slope was 1, and the intercept was log(24.0). In other words, the borderline BL is represented by the following formula (1):

$$log ( L ) = log ( {R}^{2} / ν ) + log ( 24. ) \qquad ( 1 )$$

Accordingly, the region above the borderline BL in FIG. 3 is represented by the following inequality (2):

$$log ( L ) > log ( {R}^{2} / ν ) + log ( 24. ) \qquad ( 2 )$$

Further, the following inequality (3) is obtained by expressing the inequality (2) as antilog:

$$L > 24.0 \times ( {R}^{2} / ν ) \qquad ( 3 )$$

In other words, preferred bubble generation characteristics are obtained when the inequality (3) is satisfied.

In Experimental Examples 1 to 15, the bubble generating nozzle 100 in which the gas flow path 110 had a circular cross-section was used, and R²/ν was adopted as the above-described physical quantity. However, the effect of the “shape” of the cross-section of the gas flow path 110 on the bubble generation characteristics is believed to be almost negligible.

Therefore, not only in those cases where the gas flow path 110 has a circular cross-sectional shape but also in those cases where the gas flow path 110 has a non-circular cross-sectional shape such as an elliptical shape, a triangular shape, or a polygonal shape with four or more sides, generally, when the equivalent diameter of the gas flow path 110 is represented by D, D/2 may be used in place of the above-described parameter R. It is noted here that the equivalent diameter D is defined as D=4A/W, wherein A represents a cross-sectional area of the gas flow path 110, and W represents a circumferential length of a cross-section having the cross-sectional area A, namely a circumferential length of the gas flow path 110 in an imaginary plane perpendicular to the lengthwise direction. When the gas flow path 110 has a circular cross-sectional shape, the equivalent diameter D is 2R (D=2R).

In other words, not only in those cases where the gas flow path 110 has a circular cross-sectional shape but also in those cases where the gas flow path 110 has a non-circular cross-sectional shape, generally, (D/2)²/ν may be used in place of the above-described physical quantity R²/ν. In this case, the inequality (3) is rewritten as follows:

$$L > 24.0 \times ( {D}^{2} / 4 ν ) \qquad ( 4 )$$

This inequality (4) holds true regardless of the cross-sectional shape of the gas flow path 110. In the inequality (4), the length L of the gas flow path 110 is expressed in [m], the equivalent diameter D is expressed in [m], and the kinematic viscosity ν is expressed in [m²/s]. Accordingly, the proportionality coefficient of 24.0 on the right side has a dimension of velocity [m/s].

Based on the findings obtained in the above-described Experimental Examples, the bubble generation method according to the present embodiment is described below.

First, the bubble generating nozzle 100 defining the gas flow path 110 is prepared (preparation step). At least an end of the bubble generating nozzle 100 on the side in which the bubble discharge end 110b is open is arranged in the static liquid LQ.

Next, a gas is introduced into the gas flow path 110 from the gas introduction end 110a of the gas flow path 110, and bubbles FB formed of the introduced gas are repeatedly discharged one by one into the static liquid LQ from the bubble discharge end 110b of the gas flow path 110 (bubble discharge step). The gas is introduced into the gas flow path 110 via the gas storage chamber 200 that has a larger volume than the volume of the gas flow path 110.

The most notable characteristic feature of the present embodiment is the use of the bubble generating nozzle 100 that satisfies the above-described inequality (4) in accordance with the kinematic viscosity ν of the gas used. This not only allows bubbles FB having a uniform size to be discharged, but also makes pulsation unlikely to occur during the discharge of the bubbles FB.

Further, since the bubbles FB have a uniform size and pulsation is unlikely to occur, a repetition period of the generation of the bubbles FB, a specific size of the bubbles FB, and the like can be finely controlled with, for example, the equivalent diameter D of the bubble generating nozzle 100, the pressure of the gas supplied from the gas supply source 300, and the gas pressure in the gas storage chamber 200.

Moreover, in the present embodiment, a pressurizing means such as a liquid pump is not used. In other words, the bubbles FB can be statically generated without going through a dynamic process such as dissolution, shearing, or cavitation. Therefore, during the generation of the bubbles FB, contamination hardly occurs in the static liquid LQ, and the temperature of the static liquid LQ is unlikely to change.

Preferred conditions of the length L and the equivalent diameter D of the gas flow path 110 are described below.

From the standpoint of ensuring a particularly good structural strength of the bubble generating nozzle 100 and reducing the difficulty in the production of the bubble generating nozzle 100, the length L of the gas flow path 110 is preferably 0.3×10⁻³ [m] or more, more preferably 1×10⁻³ [m] or more.

On the other hand, from the standpoint of reducing the gas supply pressure required for the discharge of the bubbles FB, the length L of the gas flow path 110 is preferably 100×10⁻³ [m] or less. When a gas pump is used as the gas supply source 300, the required power of the gas pump can be reduced by satisfying this condition.

Further, from the standpoint of reducing the difficulty in the production of the bubble generating nozzle 100, the equivalent diameter D of the gas flow path 110 is preferably 1×10⁻⁶ [m] or more. On the other hand, in order to improve the reliability of the generation of bubbles FB in a size as small as possible, specifically bubbles FB that are so-called fine bubbles of 100 μm or less in diameter, the equivalent diameter D of the gas flow path 110 is preferably 100×10⁻⁶ [m] or less.

Next, the method of producing a bubble generating nozzle according to the present embodiment is described.

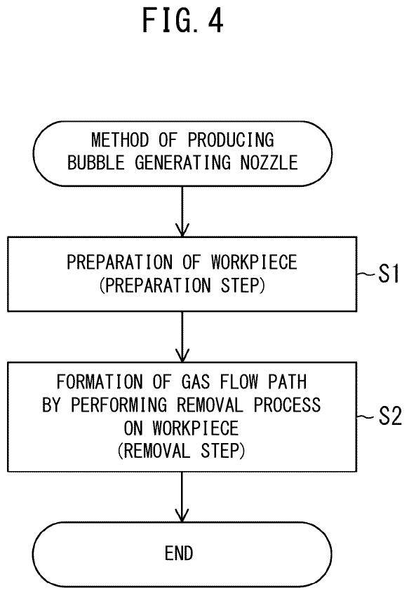

As shown in FIG. 4, first, a workpiece from which the bubble generating nozzle 100 is derived is prepared (preparation step S1). The workpiece preferably has a straight columnar shape. A material of the workpiece is not particularly limited. Examples of the material of the workpiece include metals and ceramics.

Next, a removal process of removing a portion of the workpiece is performed on the workpiece to form the gas flow path 110 in the workpiece (removal step S2). In this removal step S2, the gas flow path 110 satisfying the above-described inequality (4) is formed by the removal process.

The removal process is preferably wire electric discharge machining. In the case of performing wire electric discharge machining, a linearly extending starting hole is bored through the workpiece in advance. Subsequently, a wire is passed through the starting hole and, using the wire as one electrode and the workpiece as the other electrode, the workpiece is two-dimensionally moved relative to the wire in an imaginary plane perpendicular to the extending direction of the wire.

As a result, a portion having the same shape as the gas flow path 110 (hereinafter, referred to as “portion to be removed”) is hollowed out from the workpiece. The lengthwise direction of the linear gas flow path 110 that is defined by the hollowing-out of the portion to be removed is parallel to the depth direction of the starting hole and the extending direction of the wire. The starting hole is formed in the portion to be removed.

However, the removal process is not limited to the wire electric discharge machining. As the removal process, a hole drilling process using a drill or other rotary cutting tool may be performed. In this case, a right circular cylindrical gas flow path 110 is formed.

Further, after the removal step S2, an outer shape molding process may be performed to adjust the outer shape of the workpiece in which the gas flow path 110 has been formed. However, the outer shape molding process is not necessary when, for example, the workpiece prepared in the preparation step S1 has the shape of a straight column and a gas flow path 110 extending parallel to the height direction of the straight column is formed in the removal step S2.

### Embodiment 2

FIGS. 1 and 2 exemplify the bubble generating nozzle 100 defining only one gas flow path 110. The bubble generating nozzle 100 may define plural gas flow paths 110. A concrete example of this case is described below.

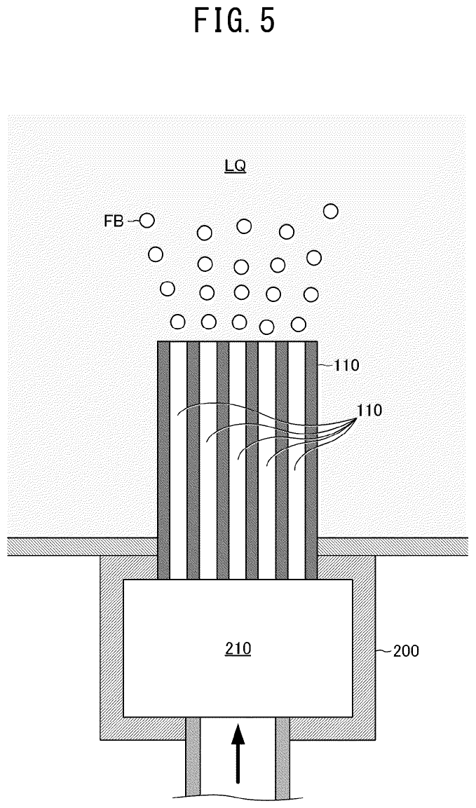

As illustrated in FIG. 5, the bubble generating nozzle 100 according to the present embodiment defines plural, specifically five, gas flow paths 110. These gas flow paths 110 each satisfies the above-described inequality (4) in relation to a gas used. Therefore, the gas flow paths 110 can each discharge bubbles FB having a uniform size, and pulsation is unlikely to occur during the discharge of the bubbles FB.

In the present embodiment, the gas storage chamber 200 is shared by all of the gas flow paths 110. In other words, all of the gas flow paths 110 are in communication with a common cavity 210. The volume of the cavity 210 is larger than the volume of each gas flow path 110, and is also larger than a total volume of all of the gas flow paths 110. It is same as in Embodiment 1 that the gas storage chamber 200 is connected to an end of the bubble generating nozzle 100.

Embodiments 1 and 2 are described above. The below-described modifications can be made as well.

FIGS. 2 and 4 exemplify a configuration in which a gas is supplied to the bubble generating nozzle 100 via the gas storage chamber 200; however, the use of the gas storage chamber 200 is not essential. That is, the gas may be fed into the gas flow path 110 through a gas pipe directly connected to the bubble generating nozzle 100, without passing through the gas storage chamber 200. As the gas pipe, typically, one having a cross-sectional area larger than the cross-sectional area A of the gas flow path 110 is used.

FIG. 1 exemplifies the gas flow path 110 that extends linearly in a straight line; however, the gas flow path 110 may have a bent portion. In this case, the length L of the gas flow path 110 that is substituted into the inequality (4) refers to a length along the gas flow path 110 from the gas introduction end 110a to the bubble discharge end 110b.

FIG. 1 illustrates the gas flow path 110 that has a straight columnar shape with a constant cross-sectional area A in the lengthwise direction of the gas flow path 110. The cross-sectional area of the gas flow path 110 (hereinafter, referred to as “local cross-sectional area”) may vary depending on the position in the lengthwise direction of the gas flow path 110. For example, the gas flow path 110 may be defined in the shape of a truncated cone shape. In this case, the cross-sectional area A of the gas flow path 110 refers to an average value of the local cross-sectional area of the gas flow path 110 over a portion from the gas introduction end 110a to the bubble discharge end 110b. Further, the equivalent diameter D is also an average value in the same manner.

FIG. 2 illustrates a structure in which the gas introduction end 110a is directly connected to the gas storage chamber 200; however, the gas introduction end 110a and the gas storage chamber 200 may be connected via a flexible pipe serving as a gas pipe. Particularly in such a case, that is, in the case of a structure that involves changes in the cross-sectional shape and the cross-sectional area of the gas flow path 110, the equivalent circle diameter may be used as the equivalent diameter D. In this case, the length L can be defined by taking a segment section ΔL from the upper end of the nozzle, calculating L/(R²/ν), and examining the relationship between L and L/(R²/ν).

The bubble generating nozzle 100 and the bubble generation device 500 according to the present embodiment can be utilized, for example, in the production of functional materials in the fields of food products, cosmetics, medicine, and the like. Specifically, synthesis of fine particles having a hollow structure with the use of the bubble generating nozzle 100 and the bubble generation device 500 according to the present embodiment enables to produce, for example, biomaterials such as three-dimensional void structure scaffolds for cell culture, protective films with reduced absorption of light, and semiconductor materials using hollow spacer particles.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-146253, filed on Sep. 14, 2022, the entire disclosure of which is incorporated by reference herein.

### REFERENCE SIGNS LIST

100 Bubble generating nozzle
110 Gas flow path
110a Gas introduction end (one end)
110b Bubble discharge end (other end)
200 Gas storage chamber
210 Cavity
300 Gas supply source
400 Liquid tank
500 Bubble generation device
BL Borderline
FB Bubble
LQ Liquid (static liquid)

1. A bubble generation device, comprising:
a gas flow path into which a gas is introduced from one end, and that discharges bubbles formed of the gas into a static liquid from an other end,
wherein the gas flow path satisfies a relationship of L>24.0×(D²/4v), where a length of the gas flow path from the one end to the other end, an equivalent diameter of the gas flow path, and a kinematic viscosity of the gas are L [m], D [m], and v [m²/s], respectively.

2. The bubble generation device according to claim 1, wherein the length L of the gas flow path is 0.3×10⁻³ [m] or more.

3. The bubble generation device according to claim 2, wherein the length L of the gas flow path is 1×10⁻³ [m] or more.

4. The bubble generation device according to claim 1, wherein the length L of the gas flow path is 100×10⁻³ [m] or less.

5. The bubble generation device according to claim 1, wherein the equivalent diameter D of the gas flow path is 1×10⁻⁶ [m] to 100×10⁻⁶ [m].

6. The A-bubble generation device according to claim 1, further comprising:
a gas storage chamber that defines a cavity communicating with the gas flow path, the cavity having a volume larger than a volume of the gas flow path, wherein
the gas is supplied to the cavity of the gas storage chamber.

7. A bubble generation method, comprising:
preparing a bubble generating member defining a gas flow path; and
introducing a gas into the gas flow path from one end of the gas flow path, and repeatedly discharging bubbles formed of the introduced gas into a static liquid from an other end of the gas flow path,
wherein the bubble generating member satisfies a relationship of L>24.0×(D²/4v), where a length of the gas flow path from the one end to the other end, an equivalent diameter of the gas flow path, and a kinematic viscosity of the gas are L [m], D [m], and v [m²/s], respectively.

8. The bubble generation method according to claim 7, wherein, in the introducing of the gas, the gas is introduced into the gas flow path via a gas storage chamber that is connected to an end of the bubble generating member on a side in which the one end of the gas flow path is open.

9. A method of producing a bubble generating member defining a gas flow path into which a gas is introduced from one end, and that discharges bubbles formed of the gas into a static liquid from an other end, wherein
the method comprises:
preparing a workpiece from which the bubble generating member is derived; and
subjecting the workpiece to a removal process of removing a portion of the workpiece, and thereby forming the gas flow path in the workpiece, and
in the subjecting, the gas flow path that satisfies a relationship of L>24.0×(D²/4v), where a length of the gas flow path from the one end to the other end, an equivalent diameter of the gas flow path, and a kinematic viscosity of the gas are L [m], D [m], and v [m²/s], respectively, is formed by the removal process.

10. The method according to claim 9, wherein, in the subjecting, the gas flow path is formed by performing wire electric discharge machining as the removal process.

11. The bubble generation device according to claim 1, wherein the gas flow path is a plurality of the gas flow paths, each of the plurality of gas flow paths satisfying the relationship of L>24.0×(D²/4v).

12. The bubble generation device according to claim 11, further comprising:
a gas storage chamber that defines a cavity communicating with each of the plurality of gas flow paths, the cavity having a volume larger than a volume of each of the plurality of gas flow paths,
wherein the gas is supplied to the cavity of the gas storage chamber.

13. The bubble generation method according to claim 7, wherein
the gas flow path is a plurality of the gas flow paths, each of the plurality of gas flow paths satisfying the relationship of L>24.0×(D²/4v),
the bubble generating member defines the plurality of gas flow paths, and
in the introducing of the gas, the gas is introduced from one end of each of the plurality of gas flow paths.

14. The method according to claim 9, wherein
the gas flow path is a plurality of the gas flow paths, each of the plurality of gas flow paths satisfying the relationship of L>24.0×(D²/4v), and
in the subjecting, each of the plurality of gas low paths is formed in the workpiece by the removal process.
